(19) United States
(12) Patent Application Publication
(10) Pub. No.: US 2013/0212319 A1
(43) Pub. Date: Aug. 15, 2013

(54) MEMORY SYSTEM AND METHOD OF CONTROLLING MEMORY SYSTEM

(71) Applicants: Toshikatsu Hida, Kanagawa (JP); Norikazu Yoshida, Kanagawa (JP); Eiji Yoshihashi, Kanagawa (JP); Hirokuni Yano, Tokyo (JP)

(72) Inventors: Toshikatsu Hida, Kanagawa (JP); Norikazu Yoshida, Kanagawa (JP); Eiji Yoshihashi, Kanagawa (JP); Hirokuni Yano, Tokyo (JP)

(73) Assignee: Kabushiki Kaisha Toshiba, Tokyo (JP)

(21) Appl. No.: 13/825,695

(22) PCT Filed: Dec. 14, 2011
(86) PCT No.: PCT/JP11/79580

§ 371 Date: Apr. 18, 2013

(30) Foreign Application Priority Data
Dec. 15, 2010 (JP) 2010-279376

(51) Int. Cl. G06F 12/02

(52) U.S. Cl. CPC G06F 12/0246
USPC 711/103

(57) ABSTRACT

According to one embodiment, a controller reads out the non-volatile address management information required to execute one of the read commands into an address information cache and retrieves data from the nonvolatile memory according to the volatile address management information stored in the address information cache. In addition, the controller among the read commands stored in the command queue, preferentially executes the read command whose logical addresses are all found in the volatile address management information.

### CROSS-REFERENCE TO RELATED APPLICATIONS

This application is based upon and claims the benefit of priority from Japanese Patent Application No. 2010-279376, filed on Dec. 15, 2010; the entire contents of which are incorporated herein by reference.

### FIELD

Embodiments described herein relate generally to a memory system and a method of controlling a memory system.

### BACKGROUND

As a memory system used in a computer system, a Solid State Drive (SSD) provided with a nonvolatile semiconductor memory therein, such as a NAND flash memory (hereinafter, simply referred to as a NAND memory), has drawn attention. In the SSD, a technique has been proposed in which the NAND memory includes a plurality of chips and an SSD controller, and the plurality of chips are connected to one another by independent channels, so that high-speed read or write is achievable.
Patent Document 1: U.S. Patent Laid-Open No. 2009/292865
Patent Document 2: Japanese Patent Application Laid-Open No. 2001-142774

### BRIEF DESCRIPTION OF THE DRAWINGS

FIG. 1 is a block diagram schematically illustrating an example of the structure of a memory system according to a first embodiment.

FIG. 2 is a block diagram schematically illustrating the functional structure of an SSD according to the first embodiment.

FIGS. 3A and 3B illustrate diagrams of examples of nonvolatile address management information.

FIG. 4 is a diagram illustrating an example of volatile address management information.

FIG. 5 is a diagram schematically illustrating an example of the structure of a reorder buffer.

FIG. 6 is a flowchart illustrating an example of a command reordering process according to the first embodiment.

FIG. 7 is a flowchart illustrating an example of a process when the operation of the SSD is completed.

FIG. 8 is a flowchart illustrating an example of a data transmission preparing process.

FIG. 9 is a flowchart illustrating an example of a process of requesting management information in advance.

FIG. 10 is a flowchart illustrating an example of read command processing.

FIG. 11 is a flowchart illustrating an example of write command processing.

FIG. 12 is a diagram schematically illustrating the outline of a reordering process.

FIG. 13 is a diagram schematically illustrating the outline of the reordering process during a read process.

FIG. 14 is a diagram schematically illustrating the outline of the reordering process according to the use conditions of channels.

FIG. 15 illustrates diagrams of examples of the registration of read commands to resource information for read when there is a limit in the number of input commands.

FIG. 16 is a diagram schematically illustrating the outline of the reordering process according to the use conditions of channels.

FIGS. 17A and 17B illustrate schematic diagrams of processes of changing the execution order of the read commands considering reusability.

FIG. 18 is a perspective view illustrating an example of a personal computer provided with the SSD.

FIG. 19 is a diagram illustrating an example of the system structure of the personal computer provided with the SSD.

### DETAILED DESCRIPTION

In the related art, a technique has not been proposed which increases throughput in the transmission of data while reducing the size of a buffer that temporarily stores data transmitted between a host apparatus and an SSD.

The following embodiments disclose a memory system capable of increasing throughput in the transmission of data while reducing the size of a buffer that temporarily stores data transmitted between a host apparatus and an SSD, as compared to the related art, and a method of controlling the memory system.

In general, according to one embodiment, there is provided a memory system including a nonvolatile memory, a command queue, an address information cache, and a controller. The nonvolatile memory is configured to store data supplied from a host apparatus and to store nonvolatile address management information in which a physical address of the nonvolatile memory and a logical address designated by the host apparatus are associated with each other. The command queue is configured to store a plurality of read and write commands issued by the host apparatus. The address information cache is configured to store volatile address management information, which is a portion of the nonvolatile address management information. The controller is configured to read out the nonvolatile address management information required to execute one of the read commands into the address information cache, retrieve data from the nonvolatile memory according to the volatile address management information stored in the address information cache, and preferentially execute, among the read commands stored in the command queue, the read command whose logical addresses are all found in the volatile address management information.

Exemplary embodiments of a memory system and a method of controlling a memory system will be explained below in detail with reference to the accompanying drawings. The present invention is not limited to the following embodiments.

### First Embodiment

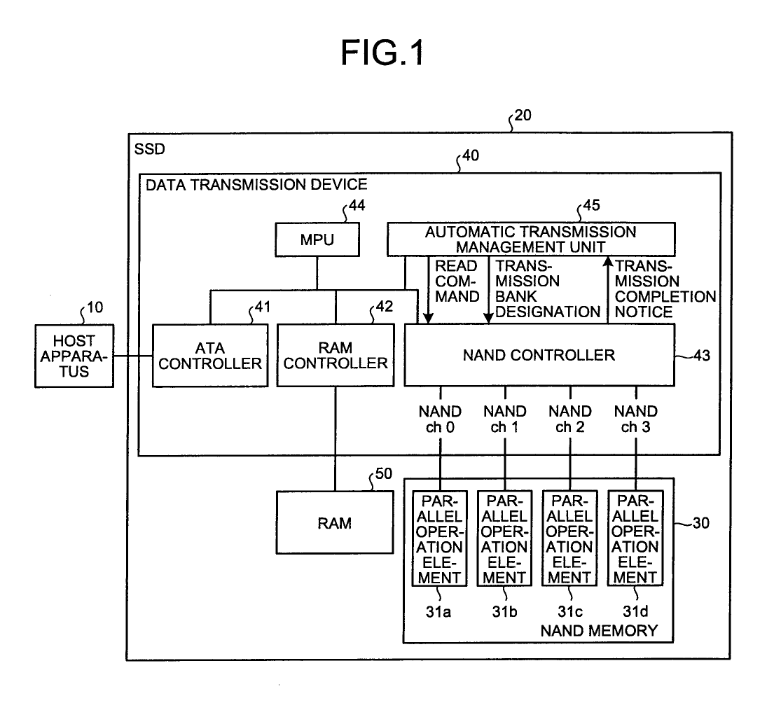

FIG. 1 is a block diagram schematically illustrating an example of the structure of a memory system according to a first embodiment. In this embodiment, an SSD is given as an example of the memory system, but this embodiment is not limited to the SSD.

An SSD 20 is connected to a host apparatus (hereinafter, referred to as a host) 10, such as a personal computer, by a communication interface based on an Advanced Technology Attachment (ATA) standard and functions as an external storage device of the host 10. The SSD 20 includes a NAND memory 30, which is a nonvolatile semiconductor memory that stores data read from or to be written to the host 10, a data transmission device 40 that controls the transmission of data in the SSD 20, and a RAM 50, which is a volatile memory that temporarily stores data to be transmitted by the data transmission device 40. Data supplied from the host 10 is stored in the RAM 50 once under the control of the data transmission device 40. Then, the data is read from the RAM 50 and is then written to the NAND memory 30. The data read from the NAND memory 30 is stored in the RAM 50 once. Then, the data is read from the RAM 50 and is then transmitted to the host 10.

The data transmission device 40 includes an ATA interface controller (hereinafter, referred to as an ATA controller) 41 that controls the operation of an ATA I/F and the transmission of data between the host 10 and the RAM 50, a RAM controller 42 that controls the reading/writing of data from/to the RAM 50, a NAND controller 43 that controls the transmission of data between the NAND memory 30 and the RAM 50, an MPU 44 that controls the overall operation of the data transmission device 40 on the basis of firmware, and an automatic transmission management unit 45 that manages the reading of data from the NAND memory 30 and the transmission of data read from the NAND memory 30 to the RAM 50. The MPU 44, the ATA controller 41, the RAM controller 42, the NAND controller 43, and the automatic transmission management unit 45 are connected to a bus. The automatic transmission management unit 45 is a host controller of the NAND controller 43. The automatic transmission management unit 45 manages the read control of the NAND memory 30 by the NAND controller 43 under the control of the MPU 44.

The NAND memory 30 stores user data designated by the host 10 or stores management information managed by the RAM 50 for backup. In this case, the NAND memory 30 includes four parallel operation elements 31a to 31d that perform four parallel operations. The parallel operation elements 31a to 31d are connected to the NAND controller 43 through channels ch0 to ch3, respectively. The four parallel operation elements 31a to 31d may be operated independently or in parallel according to settings. The NAND memory 30 further includes a memory cell array including a plurality of memory cells arranged in a matrix. Each of the memory cells may store multi-valued data using an upper page and a lower page. The NAND memory 30 includes a plurality of memory chips. Each of the memory chips is formed by arranging a plurality of physical blocks each of which is a data erasing unit. In the NAND memory 30, the writing and reading of data are performed for each physical page. The physical block includes a plurality of physical pages. In the SSD 20, the physical blocks are divided into free blocks which do not include valid data and to which the purpose of use is not allocated and active blocks which include valid data and to which the purpose of use is allocated. The SSD 20 manages the divided blocks. In this embodiment, the NAND memory 30 includes the four parallel operation elements 31a to 31d. However, the number of parallel operation elements is not limited to four.

The RAM 50 is used as a storage unit for data transmission, a storage unit for recording the management information, or a storage unit for a work area. Specifically, the storage unit (buffer for data transmission) for data transmission temporarily stores data which is requested to be written by the host 10 before the data written to the NAND memory 30, or it reads data which is requested to be read by the host 10 from the NAND memory 30 and temporarily stores the read data. The storage unit for recording the management information is used to store management information (for example, management tables expanded when some of various kinds of management tables stored in the NAND memory 30 start and a log, which is the change difference information of the management tables) for managing, for example, the correspondence between the storage position of data in the NAND memory 30 and the logical address designated by the host 10.

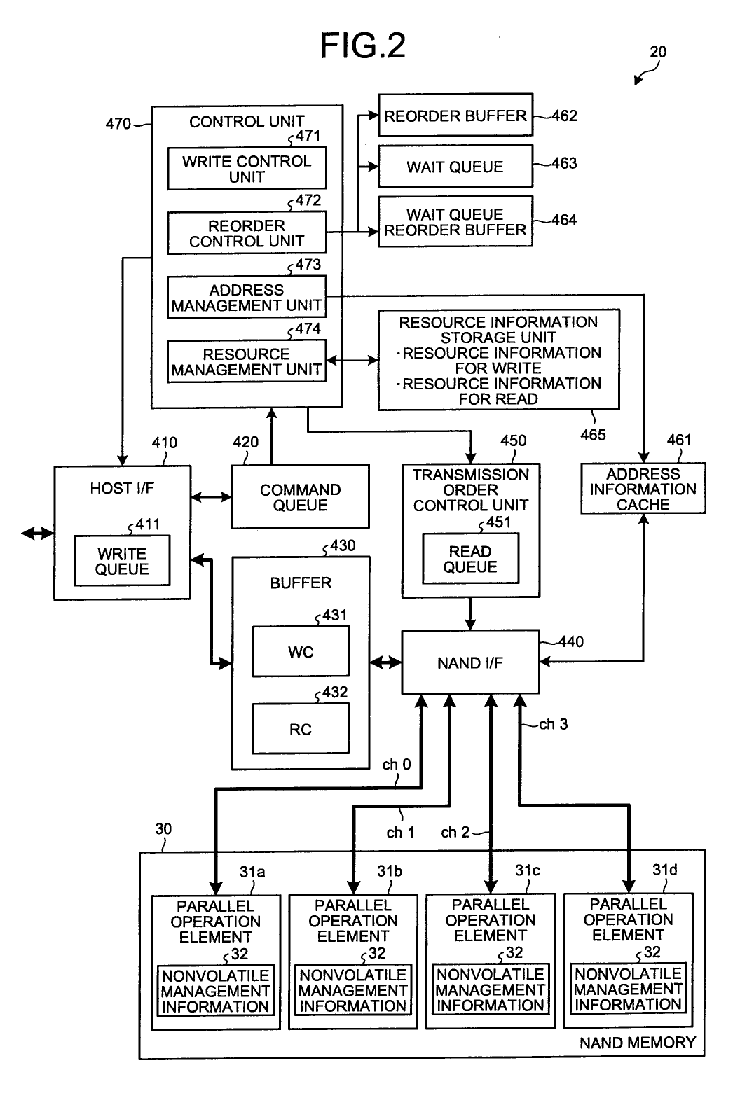

FIG. 2 is a block diagram schematically illustrating the functional structure of the SSD according to the first embodiment. In the functional structure, the SSD 20 includes a host interface (hereinafter, referred to as a host I/F) 410, a command queue 420, a buffer 430, a NAND memory 30, a NAND interface (hereinafter, referred to as a NAND I/F) 440, a transmission order control unit 450, an address information cache 461, a reorder buffer 462, a wait queue 463, a wait queue reorder buffer 464, a resource information storage unit 465, a resource information storage unit 465, and a control unit 470.

Each functional block shown in FIG. 2 may be implemented by hardware, software, or a combination thereof. Therefore, each functional block will be described below from the viewpoint of these functions such that the functions become clear. Whether the functions are implemented by hardware or software depends on embodiments or design constraint in the entire system. The skilled in the art can implement these functions using various methods for each embodiment and the determination of the implement is included in the scope of the invention.

In a write process (writing process), the host I/F 410 receives commands issued by the host 10 and receives data to be written to the NAND memory 30. In a read process (reading process), the host I/F 410 receives commands from the host 10 and outputs data stored in the buffer 430 to the host 10. The host I/F 410 includes a write queue 411 that receives a write command which is requested to be executed by the control unit 470. The host I/F 410 executes the commands in the order in which the commands are allocated in the write queue 411.

The command queue 420 stores the commands received through the host I/F 410. The buffer 430 includes a write cache (represented by WC in FIG. 2) 431 that temporarily stores data for performing the write process when a write command is received and a read cache (represented by RC in FIG. 2) 432 that temporarily stores data read from a storage position of the NAND memory 30 corresponding to an LBA included in a read command when the read command is received.

As described above, the NAND memory 30 includes the four parallel operation elements 31a to 31d which are connected to the NAND I/F 440 by the channels ch0 to ch3, respectively, and stores, for example, software required to operate the SSD 20, data which is requested to be written by the host 10, and nonvolatile management information 32 for managing the storage position of data in the NAND memory 30. The nonvolatile management information 32 includes address-channel correspondence information for defining the range of the logical addresses managed by the parallel operation elements 31a to 31d in the NAND memory 30 and nonvolatile address management information for managing the storage position of all data in the NAND memory 30. In this embodiment, the nonvolatile management information 32 is provided in each of the parallel operation elements 31a to 31d. However, the nonvolatile management information 32 may be provided in at least one of the four parallel operation elements 31a to 31d. In addition, the address-channel correspondence information may be provided in any one of the parallel operation elements 31a to 31d.

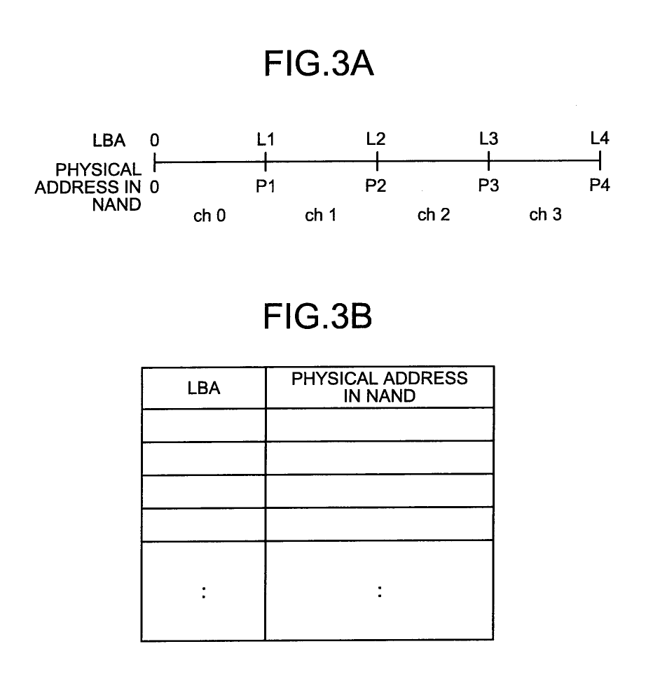

FIGS. 3A and 3B are diagrams illustrating examples of the nonvolatile address management information. FIG. 3A is a diagram illustrating an example of the address-channel correspondence information and FIG. 3B is a diagram illustrating an example of the nonvolatile address management information. The address-channel correspondence information associates a Logical Block Addressing (LBA), which is a logical address input from the host 10, with each of the parallel operation elements 31a to 31d (channels ch0 to ch3). The LBA is a logical address which is attached to a sector (size: 512B) and has a serial number starting from 0. The sector size is not limited thereto.

In this example, as the address-channel correspondence information, as shown in FIG. 3A, the parallel operation element 31a (physical address 0˜P1) connected to the channel ch0 is allocated to an LBA 0˜L1 and the parallel operation element 31b (physical address P1˜P2) connected to the channel ch1 is allocated to an LBA L1˜L2. The parallel operation element 31c (physical address P2˜P3) connected to the channel ch2 is allocated to an LBA L2˜L3 and the parallel operation element 31d (physical address P3˜P4) connected to the channel ch3 is allocated to an LBA L3˜L4. As such, the address-channel correspondence information is used to manage the association between the LBA and the physical address in the NAND memory 30 for each channel (for each of the parallel operation elements 31a to 31d).

As shown in FIG. 3B, the nonvolatile address management information is used to manage the association between the LBA, which is the logical address designated by the host 10, and the physical address indicating the actual storage position on the NAND memory 30. In this embodiment, for example, it is assumed that the association between the LBA and the physical address in the NAND memory 30 is managed for each sector, unlike the address-channel correspondence information. The unit of address translation may be more than double the sector size. In the SSD 20, the relation between the logical address and the physical address is not statically determined in advance, but a logical-physical translation method which is dynamically associated with the writing of data is used.

The NAND I/F 440 controls the transmission of data between the NAND memory 30 and the buffer 430 in response to the command from the transmission order control unit 450.

The transmission order control unit 450 includes a read queue 451 that receives read commands which are requested to be executed by the control unit 470 and executes the commands in the order allocated in the read queue 451. When the command is executed, the transmission order control unit 450 controls the reading of data from the NAND memory 30 and the transmission of the read data to the host 10. When the management information is read, the transmission order control unit 450 controls the reading of the address management information from the NAND memory 30 to the address information cache 461.

As disclosed in U.S. patent application Ser. No. 13/238,191, the entire contents of which are incorporated herein by reference, the transmission order control unit 450 expands one read command to a plurality of read command strings in the order of LBAs, reads data corresponding to the read command strings in the order of LBAs from the NAND memory 30 to the buffer 430, and transmits the data to the host 10. In this embodiment, data is read from the NAND memory 30 in the order of LBAs. However, data is not read in the order of LBAs, but data may be transmitted from the buffer to the host 10 in the order of LBAs, regardless of the order in which data is read to the buffer 430.

In addition, the transmission order control unit 450 issues a request which can be issued to the NAND I/F 440 among the read commands allocated in the read queue 451 in advance. For example, while the data of a given read command is transmitted, the transmission order control unit 450 issues a request for the succeeding read command allocated in the read queue 451 to the NAND I/F 440 in advance and prepares a data transmitting process. When the transmission of the data of the read command is completed, the request for the read command issued to the NAND I/F 440 is executed and the request for the succeeding read command allocated in the read queue 451 is issued to the NAND I/F 440 in advance. In this embodiment, as the request issued to the NAND I/F 440 when data is transmitted in response to the request for the preceding read command, a request for a different read command may be issued, or the succeeding request in the read command may be issued such that data which is being transmitted is read in the order of LBAs.

The address information cache 461 stores volatile address management information, which is a portion of the nonvolatile address management information in the NAND memory 30. The volatile address management information is used to read the data in the NAND memory 30 designated by the LBA of the read command. The address management information including the LBA of the read command is read from the nonvolatile address management information in the NAND memory and is expanded in the address information cache 461. As such, in the SSD 20, the storage position of all data in the NAND memory 30 is not read to the cache memory and managed, but a method of reading and managing the storage position of a portion of the data in the NAND memory 30, if necessary, is used. According to this structure, it is possible to reduce the capacity of a cache memory (address information cache 461).

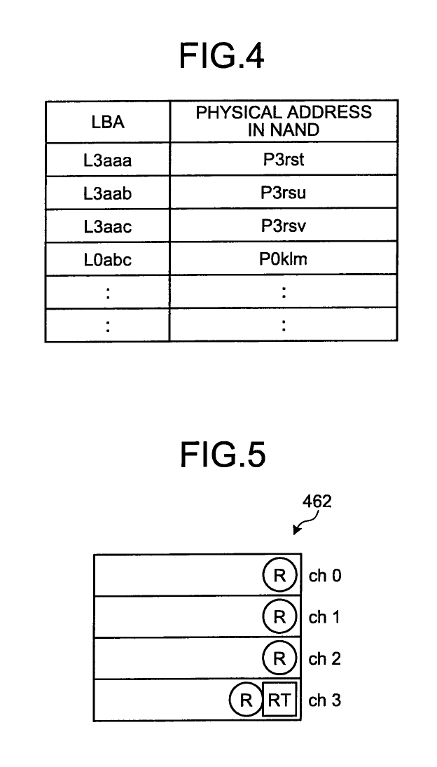

FIG. 4 is a diagram illustrating an example of the volatile address management information. The volatile address management information has the same structure as the nonvolatile address management information shown in FIG. 3B. As described above, address management information on the storage position of a portion of the data in the NAND memory 30, not address management information on the storage position of all data in the NAND memory 30, is stored. The capacity of the address information cache 461 is determined by the function of the SSD 20. When there is no physical address corresponding the LBA of the data requested by the command from the host 10 in the NAND memory 30, the control unit 470 updates the volatile address management information such that the physical address is included.

The reorder buffer 462 temporarily stores the command that is determined to be executable by the control unit 470. Specifically, the reorder buffer 462 temporarily stores the commands which do not have dependence and whose access destination addresses are managed in the address information cache 461, which will be described below. FIG. 5 is a diagram schematically illustrating an example of the structure of the reorder buffer. As shown in FIG. 5, the commands may be allocated so as to correspond to the channels ch0 to ch3 (parallel operation elements 31a to 31d) of the NAND memory 30. In FIG. 5, R indicates a read command and RT indicates a command to read the management information required to execute the read command.

The wait queue 463 is a buffer that temporarily stores the command which is not immediately executable by the control unit 470. Specifically, the wait queue 463 temporarily stores the read command whose access destination address is not managed in the address information cache 461. In an environment capable of executing a command, the control unit 470 moves the commands to the reorder buffer 462.

The wait queue reorder buffer 464 reads the address management information required to specify the address on the NAND memory 30 from the nonvolatile management information 32 of the NAND memory 30, in response to the read command among the commands sorted in the wait queue 463 and temporarily stores a management information read command to be allocated in the address information cache 461. The wait queue reorder buffer 464 has the same structure as the reorder buffer shown in FIG. 5 and is capable of allocating commands so as to correspond to the channels ch0 to ch3 (parallel operation elements 31a to 31d) of the NAND memory 30.

The resource information storage unit 465 includes resource information for write indicating a free space of the write cache 431 in the buffer 430 and resource information for read indicating the command reception state (processing state) of the NAND memory 30. As the resource information for read, the following may be used: the number of commands received by the NAND memory 30 (the number of commands that can be received by the NAND memory 30 at a time); the number of commands accumulated in each of the parallel operation elements 31a to 31d (channels ch0 to ch3); or a combination thereof.

The control unit 470 includes a write control unit 471 that controls the writing of the write command stored in the command queue 420, a reorder control unit 472 that controls the order in which the read commands stored in the command queue 420 are executed, an address management unit 473 that converts the address of the command stored in the command queue 420 and manages the address information cache 461, and a resource management unit 474 that manages the free space of the write cache 431 in the buffer 430 and the command reception state of the NAND memory 30.

The write control unit 471 performs a process of writing data to the write cache 431 of the buffer 430 or a process of writing data in the write cache 431 to the NAND memory 30, in response to the write command. In addition, when it is determined that the free space of the write cache 431 is more than the amount of data to be written by the write command on the basis of the resource information for write in the resource information storage unit 465, the writing unit 471 determines that all write commands without dependence, which will be described below, are executable. If not, the writing unit 471 determines that all write commands without dependence are not executable. The writing unit 471 also has a function of arranging an environment such that the write command which is not immediately executable can be executed. Specifically, the writing unit 471 performs a process of ensuring a free space such that the amount of data transmitted to the write cache 431 can be written. For example, the writing unit 471 performs a process of moving the oldest data among the data stored in the write cache 431 to the NAND memory 30. The process of writing data to the NAND memory 30 acquires a block including the LBA of data to be moved in the NAND memory 30, updates the data in the block with data in the write cache 431, and writes the updated data to a new (another) block in the NAND memory 30. In this case, the block having old data stored therein is invalidated. Then, the writing unit 471 allocates an executable write command to hardware (the write queue 411 of the host I/F 410) without any conditions.

The reorder control unit 472 determines whether there is a dependence between the commands stored in the command queue 420. When there is a dependence, the reorder control unit 472 stops the execution of the commands until the dependence is cancelled. As the dependence between the commands, there are three types of dependences, that is, Read After Write (hereinafter, referred to as RAW), Write After Write (hereinafter, referred to as WAW), and Write After Read (hereinafter, referred to as WAR). RAW corresponds to a case in which the succeeding read request overtakes the preceding write request and old data with the same LBA as that in the preceding write request is read. WAW corresponds to a case in which the succeeding write request overtakes the preceding write request with the same address and old write data remains finally. WAR corresponds to a case in which the succeeding write request overtakes the preceding read request and future data is read.

The dependence is established when the preceding request and the succeeding request have the same address. Therefore, the reorder control unit 471 checks the access destinations of the commands stored in the command queue 420. When the preceding command (the command that is allocated first) and the succeeding command (the command that is allocated later) have the same access destination address and have the relation RAW, WAW, or WAR therebetween, the reorder control unit 471 performs a process of stopping the execution of the commands.

The reorder control unit 472 performs a process of storing the commands which are not immediately executable among the commands having dependence therebetween in the reorder buffer 462 and stores the commands which are immediately executable in the wait queue 463. For example, when the LBA of the access destination of the command is converted into the physical address in the NAND memory 30 by the address management unit 473, the command is immediately executable. If not, the command is not immediately executable.

The reorder control unit 472 controls the input of the command allocated in the reorder buffer 462 to hardware (the read queue 451 of the transmission order control unit 450) on the basis of the resource information for read. For example, in the case in which the number of all commands input to the NAND memory 30 is used as the resource of the NAND memory 30, when the number of all commands input to the NAND memory 30 is equal to a predetermined threshold value, the read command is not input. When the number of all commands is less than the predetermined threshold value, the number of read commands obtained by subtracting the number of all allocated commands from the threshold value is allocated. In addition, in the case in which the number of commands accumulated in each of the parallel operation elements 31a to 31d is used as the resource of the NAND memory 30, when the number of cumulative commands of the parallel operation elements which allocate the read commands is equal to a predetermined threshold value, the read command is not allocated. When the number of cumulative commands is less than the threshold value, the read commands are sequentially allocated to the empty parallel operation elements 31a to 31d in a round-robin fashion in the direction in which a channel number increases.

In this case, the reorder control unit 472 determines whether there are read commands accessing the same address (page) on the basis of the addresses of the read commands. When there are read commands accessing the same address (page) or successive addresses (page), the reorder control unit 472 determines the order of the read commands so as to be continuously executed.

For example, the reorder control unit 472 acquires an LBA, which is the access destination address of the read command in the wait queue 463, specifies the parallel operation element having the LBA from the address-channel correspondence information, and specifies the address management information in which the correspondence between the LBA and the physical address in the NAND memory 30 is recorded from the nonvolatile address management information of the specified parallel operation element. Then, the reorder control unit 472 creates a management information read command to read the specified address management information from the NAND memory 30, allocates the created management information read command to the wait queue reorder buffer 464, and controls the input of the command to hardware (the read queue 451 of the transmission order control unit 450) on the basis of the resource information for read. In addition, in the stage in which all information (address management information) required to resolve the recording position of data read by the command in the wait queue 463 is acquired (allocated in the address information cache 461), the reorder control unit 472 allocates the command from the wait queue 463 to the reorder buffer 462. When the management information read command is executed, the address management information which is used by the read command allocated in the reorder buffer 462 remains, and the address management information which is not used by the read command allocated in the reorder buffer 462 is removed. The acquired address management information is allocated in the region from which the address management information is removed.

For the read commands without dependence, the address management unit 473 converts the access destination address (LBA) of the read command into the physical address in the NAND memory 30 using the address management information of the address information cache 461 and notifies the translation result to the reorder control unit 472. When it is possible to specify the position of the access destination on the NAND memory 30 using only the address management information of the address information cache 461, the physical address on the NAND memory 30 is notified to the reorder control unit 472. When it is difficult to specify the position of the access destination on the NAND memory 30 using the address management information of the address information cache 461, information indicating that it is difficult to specify the physical address is notified to the reorder control unit 472.

The resource management unit 474 manages the free space of the write cache 431 in the buffer 430 which is required to execute the write command as the resource information for write, manages the command reception state of the NAND memory 30 required to execute the read command as the resource information for read, and update information in the resource information storage unit 465 when the resource information for write and the resource information for read are changed.

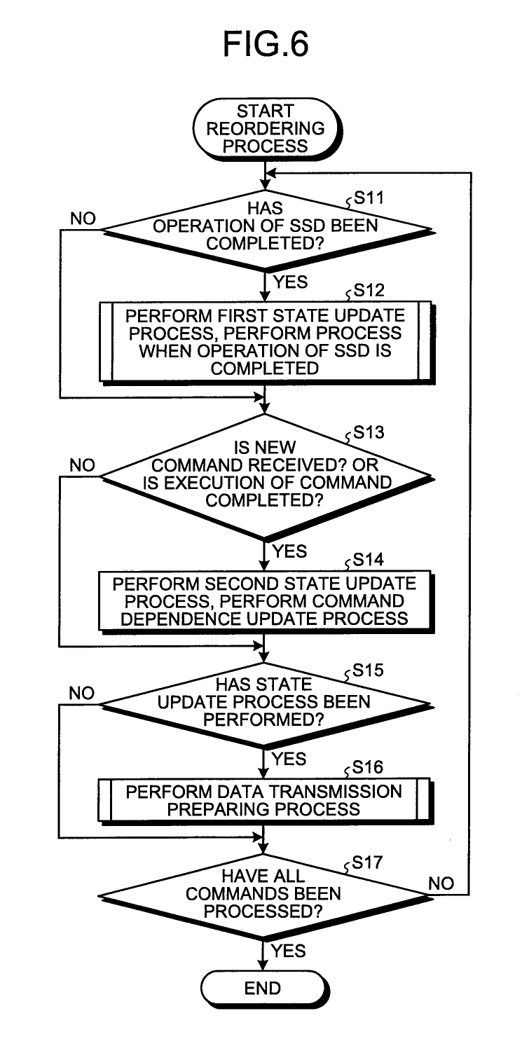

Next, a command reordering process of the SSD 20 having the above-mentioned structure will be described. FIG. 6 is a flowchart illustrating an example of the command reordering process according to the first embodiment. First, the reorder control unit 472 determines whether the operation of the SSD 20 on the previously executed command is completed (Step S11). For example, the reorder control unit 472 determines whether there is a change in the internal state of the SSD 20, such as the completion of the reading of the address management information or the completion of the reading of data corresponding to one page from the NAND memory 30. Then, as a first state update process, a process when the operation of the SSD 20 is completed is performed (Step S12).

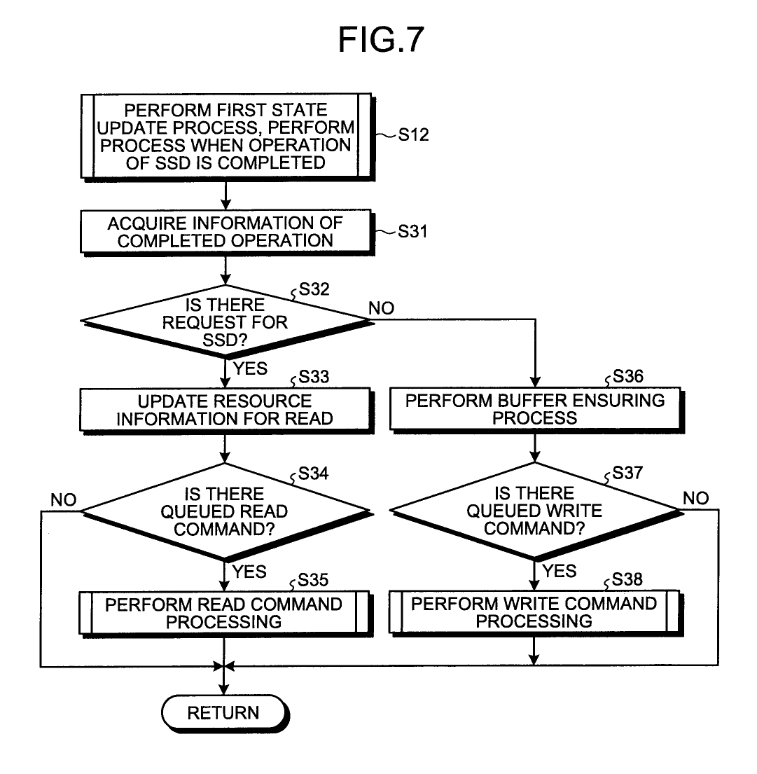

FIG. 7 is a flowchart illustrating an example of the process when the operation of the SSD is completed. The reorder control unit 472 acquires the information of the operation completed by the previously executed command (Step S31) and determines whether the completed operation is a request to read data to the SSD 20 (Step S32). When the completed operation is a request to read data to the SSD 20 (Yes in Step S32), the resource management unit 474 updates the resource information for read in the resource information storage unit 465 (Step S33).

Then, the reorder control unit 472 determines whether there is a queued read command (Step S34). When there is a queued read command (Yes in Step S34), a read command execution process, which will be described below, is performed (Step S35). After the read command execution process is performed or when there is no queued read command (No in Step S34), the process returns to the flowchart shown in FIG. 6.

When the operation completed in Step S32 is a request to write data to the SSD 20 (No in Step S32), the write control unit 471 ensures the write cache 431 of the buffer 430 (Step S36). In this case, the resource management unit 474 updates the resource information for write in the resource information storage unit 465.

Then, it is determined whether there is a queued write command (Step S37). When there is a queued write command (Yes in Step S37), a write command execution process, which will be described below, is performed (Step S38). After the write command execution process is performed or when there is no queued write command (No in Step S37), the process returns to the flowchart shown in FIG. 6.

Returning to the flowchart shown in FIG. 6, after the process when the operation of the SSD 20 is completed in Step S12 ends or when the operation of the SSD 20 in Step S11 is completed (No in Step S11), it is determined whether a new command is received or the execution of the command is completed (Step S13). When a new command is received or the execution of the command is completed (Yes in Step S13), a command dependence update process is performed as a second state update process (Step S14). It is checked whether dependence is established between the commands by the reception of a new command, and it is checked whether the dependence between the commands is broken by the completion of the execution of the command.

After the command dependence update process is performed or when a new command is not received and the execution of the command is not completed in Step S13 (No in Step S13), it is determined whether the first and second state update processes have been performed (Step S15). When the first and second state update processes have been performed (Yes in Step S15), a data transmission preparing process is performed (Step S16).

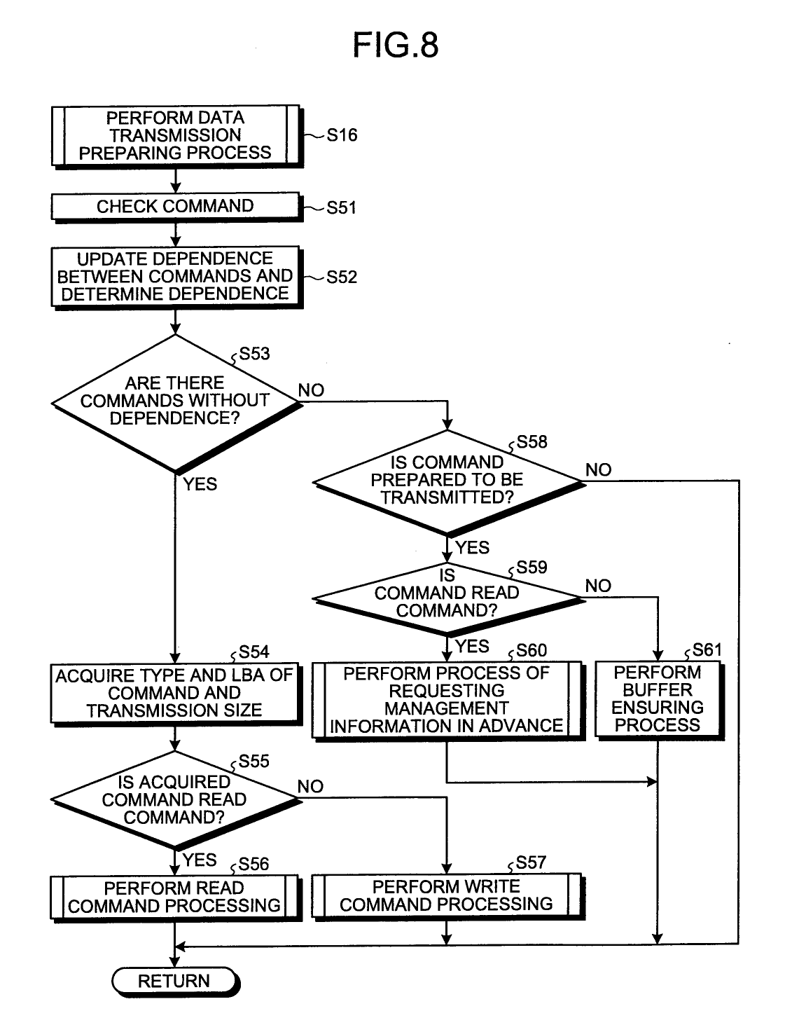

FIG. 8 is a flowchart illustrating an example of the data transmission preparing process. First, a command output from the host 10 is input to the SSD 20 through the host I/F 410 and the command queue 420 receives a new command (Step S51). Then, the reorder control unit 472 updates the dependence between the queued commands and determines whether there is a dependence between the commands (Step S52). In addition, the reorder control unit 472 determines whether there is a command without dependence (Step S53). For the dependence between the commands, for example, the reorder control unit 472 determines whether the relation RAW, WAW, or WAR is established between the commands on the basis of the access destination addresses of the commands stored in the command queue 420.

When there are commands without dependence (Yes in Step S53), the reorder control unit 472 acquires the type and LBA of the commands and the transmission size of data executed by the commands (Step S54). Then, it is determined whether the acquired command is a read command (Step S55). When the acquired command is a read command (Yes in Step S55), the reorder control unit 472 performs read command processing, which will be described below, (Step S56) and the process returns to the flowchart shown in FIG. 6. When the acquired command is not a read command (No in Step S55), the write control unit 471 performs write command processing, which will be described below, (Step S57) and the process returns to the flowchart shown in FIG. 6.

On the other hand, when it is determined in Step S53 that there are commands having dependence therebetween (No in Step S53), it is determined whether the command is not prepared to be transmitted (Step S58). When the command is prepared to be transmitted (No in Step S58), the process returns to the flowchart shown in FIG. 6.

When the command is not prepared to be transmitted (Yes in Step S58), it is determined whether the command is a read command (Step S59). When the command is a read command (Yes in Step S59), the reorder control unit 472 performs a process of requesting management information in advance (Step S60). This process acquires the address management information used to acquire the data of the access destination of the command in advance when the command to be executed is a read command with dependence.

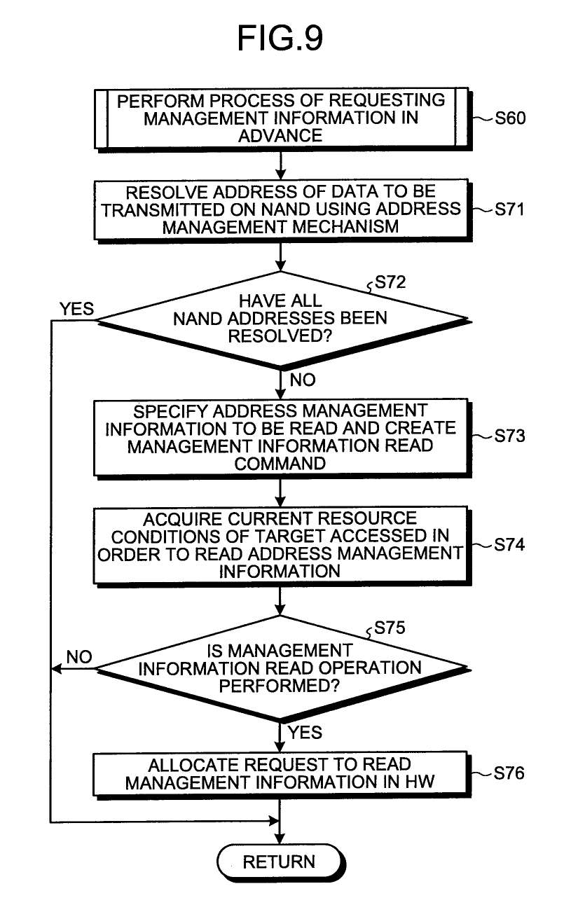

FIG. 9 is a flowchart illustrating an example of the process of requesting management information in advance.

First, the address management unit 473 performs a process of resolving the physical address of the data to be transmitted on the NAND memory 30 on the basis of the volatile address management information in the address information cache 461 (Step S71). Then, the reorder control unit 472 determines whether it is possible to resolve the address on the NAND memory 30 on the basis of the result of the process (Step S72). Specifically, the address management unit 473 determines whether the LBA included in the read command is converted into a physical address indicating a recording position in the NAND memory 30. When the physical address is returned by the address management unit 473, the reorder control unit 472 determines that it is possible to resolve the physical address of the data to be transmitted on the NAND memory 30. When the physical address is not returned, the reorder control unit 472 determines that it is difficult to resolve the physical address of the data to be transmitted on the NAND memory 30.

When it is possible to resolve the physical address of the data to be transmitted on the NAND memory 30 (Yes in Step S72), the volatile address management information in the address information cache 461 can be resolved and it is not necessary to acquire new address management information. Therefore, the process of requesting the address management information in advance ends and the process returns to the flowchart shown in FIG. 8.

When it is difficult to resolve the physical address of the data to be transmitted on the NAND memory 30 (No in Step S72), the reorder control unit 472 specifies the address management information to be read and creates a management information read command to read the address management information to be read (Step S73). The address management information to be read is information indicating the correspondence between an LBA which is not included in the volatile address management information among the LBAs designated by the read command and a physical address on the NAND memory 30. The reorder control unit 472 acquires the parallel operation element storing the address management information to be read from the address-channel correspondence information and acquires the storage position of the address management information to be read, thereby creating the management information read command. Then, the reorder control unit 472 arranges the created management information read command in a queue corresponding to the parallel operation element, which is the access destination of the wait queue reorder buffer 464.

Then, the reorder control unit 472 acquires the current resource conditions of the NAND I/F 440 (parallel operation elements 31a to 31d) accessed when the address management information is read (Step S74) and determines whether to execute the management information read command (Step S75). Specifically, the reorder control unit 472 acquires the current resource information for read from the resource information storage unit 465 and determines whether the command can be input to the NAND I/F 440 on the basis of the resource information for read. When the amount of resource of the NAND I/F 440 to be accessed is full, the management information read command is not executed. When the amount of resource of the NAND I/F 440 to be accessed is not full, it is determined that the management information read command is executed.

When it is determined that the management information read command is executed (Yes in Step S75), the management information read command is allocated to hardware (in this embodiment, the read queue 451 of the transmission order control unit 450) (Step S76) and the process returns to the flowchart shown in FIG. 8. When it is determined that the management information read command is not executed (No in Step S75), the process of requesting the address management information in advance ends and the process returns to the flowchart shown in FIG. 8.

As shown in FIG. 9, the process of acquiring the address management information in advance is performed for the read command which is not subjected to the data transmission preparing process among the read commands having dependence therebetween. When the process ends, the process returns to the flowchart shown in FIG. 6.

Returning to the flowchart shown in FIG. 8, when there is a write command in Step S59 (No in Step S59), the write control unit 471 ensures a region to which transmission data designated by the write command is written in the write cache 431 of the buffer 430 (Step S61) and the process returns to the flowchart shown in FIG. 6.

Returning to the flowchart shown in FIG. 6 again, after the data transmission preparing process in Step S16 is performed or when the first and second state update processes in Step S15 are not performed (No in Step S15), the reorder control unit 472 determines whether all commands in the command queue 420 are completely processed (Step S17). When all commands are not completely processed (No in Step S17), the process returns to Step S11. When all commands are completely processed (Yes in Step S17), the reordering process ends.

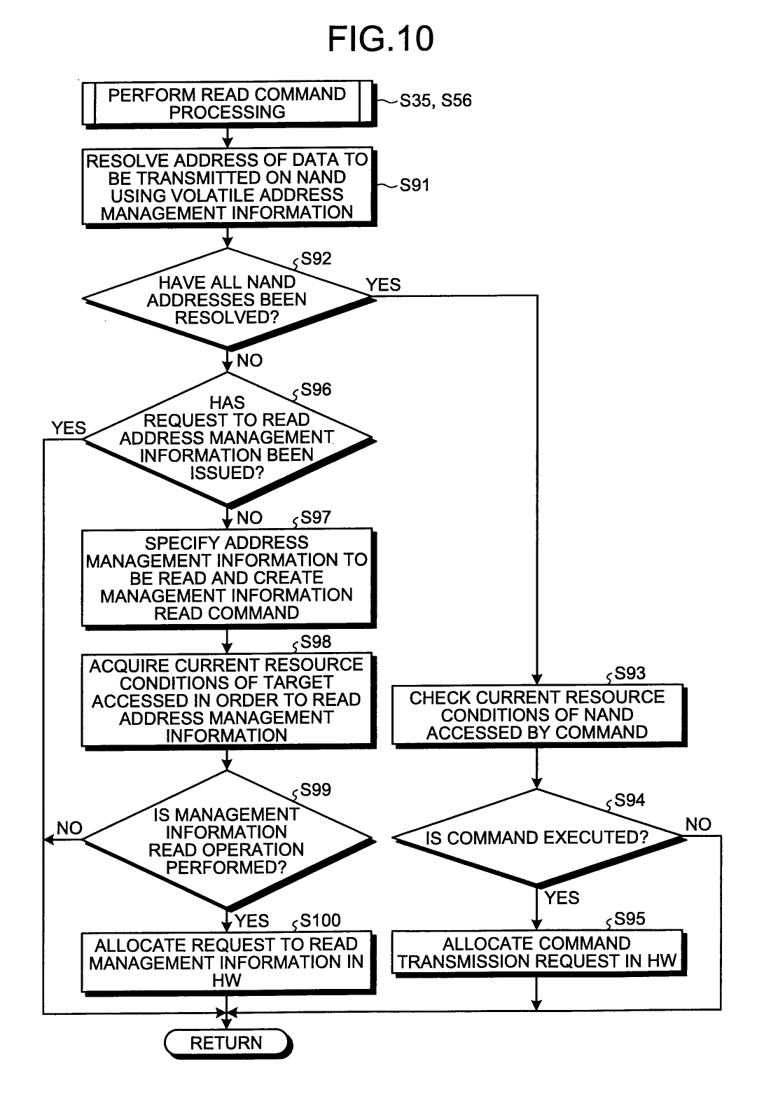

Next, the read command processing in Step S35 of FIG. 7 and Step S56 of FIG. 8 will be described in detail. FIG. 10 is a flowchart illustrating an example of the read command processing. First, the address management unit 473 resolves the physical address of the data to be transmitted on the NAND memory 30 using the volatile address management information in the address information cache 461 (Step S91). The reorder control unit 472 determines whether it is possible to resolve the address of the data to be transmitted on the NAND memory 30 on the basis of the resolution result (Step S92).

The reorder control unit 472 notifies the LBA of the read command and the transmission size to the address management unit 473. The address management unit 473 converts the received LBA into a physical address on the NAND memory 30 using the volatile address management information in the address information cache 461. In this case, when the physical address on the NAND memory 30 corresponding to the received LBA is in the volatile address management information, the physical address converted from the LBA returns to the reorder control unit 472. On the other hand, when the physical address on the NAND memory 30 corresponding to the received LBA is not in the volatile address management information, a signal indicating that there is no physical address (for example, the received LBA) returns to the reorder control unit 472. In this way, the reorder control unit 472 can determine whether it is possible to resolve the address of the data to be transmitted on the NAND memory 30.

When it is possible to resolve the address of the data to be transmitted on the NAND memory 30 (Yes in Step S92), the reorder control unit 472 determines that the read command can be executed. In this case, the reorder control unit 472 stores the read command in a queue corresponding to the parallel operation element, which is an access destination, in the reorder buffer 462.

Then, the reorder control unit 472 checks the resource conditions of the NAND I/F 440 through which data is transmitted by the read command, using the resource information for read in the resource information storage unit 465 (Step S93), and determines whether to execute the read command (Step S94). The reorder control unit 472 determines that the read command is executable when the amount of resource of the NAND I/F 440, which is the access destination of the read command allocated in the reorder buffer 462, is less than a predetermined value, and determines that the read command is not executable when the amount of resource of the NAND I/F 440 is equal to the predetermined value. In addition, when the resource conditions are checked in Step S93, it may be determined whether the command is executable, considering the reusability or continuity of the command. For example, when there are read commands that access the same address or successive addresses, the read commands may be reordered so as to be continuously processed and it may be determined whether the read commands are executed on the basis of the resource information for read.

As a result of a determination, when it is determined that the command is not executed (No in Step S94), the read command processing ends and the process returns to the flowchart shown in FIG. 7 or FIG. 8. When it is determined that the command is executed (Yes in Step S94), a read command transmission request is allocated to hardware (in this embodiment, the read queue 451 of the transmission order control unit 450) (Step S95) and the process returns to the flowchart shown in FIG. 7 or FIG. 8.

When it is difficult to resolve the address of the data to be transmitted on the NAND memory 30 in Step S92 (No in Step S92), the reorder control unit 472 determines whether the management information read command to read the address management information used to transmit data with the read command has been issued (Step S96). When the management information read command has been issued (Yes in Step S96), the read command processing ends and the process returns to the flowchart shown in FIG. 7 or FIG. 8.

When the management information read command has not been issued (No in Step S96), the reorder control unit 472 specifies the address management information to be read and creates the management information read command (Step S97).

Then, the reorder control unit 472 acquires the current resource conditions of the NAND I/F 440 (parallel operation element) accessed when the address management information is read, that is, the resource information for read (Step S98) and determines whether to execute the management information read command on the basis of the resource conditions (Step S99).

When it is determined that the management information read command is executed (Yes in Step S99), the management information read command is allocated to hardware (in this embodiment, the read queue 451 of the transmission order control unit 450) (Step S100) and the process returns to the flowchart shown in FIG. 7 or FIG. 8. When it is determined that the management information read command is not executed (No in Step S99), the read command processing ends and the process returns to the flowchart shown in FIG. 7 or FIG. 8.

As described above, in the read command processing, when it is possible to resolve the physical address of all data to be transmitted on the NAND memory 30 using the volatile address management information in the address information cache 461, it is determined whether to transmit the read command to hardware on the basis of the amount of resource of the NAND I/F 440. When it is difficult to resolve the physical address on the NAND memory 30 using the volatile address management information, the management information read command to allocate the address management information used to execute the read command in the address information cache 461 is issued.

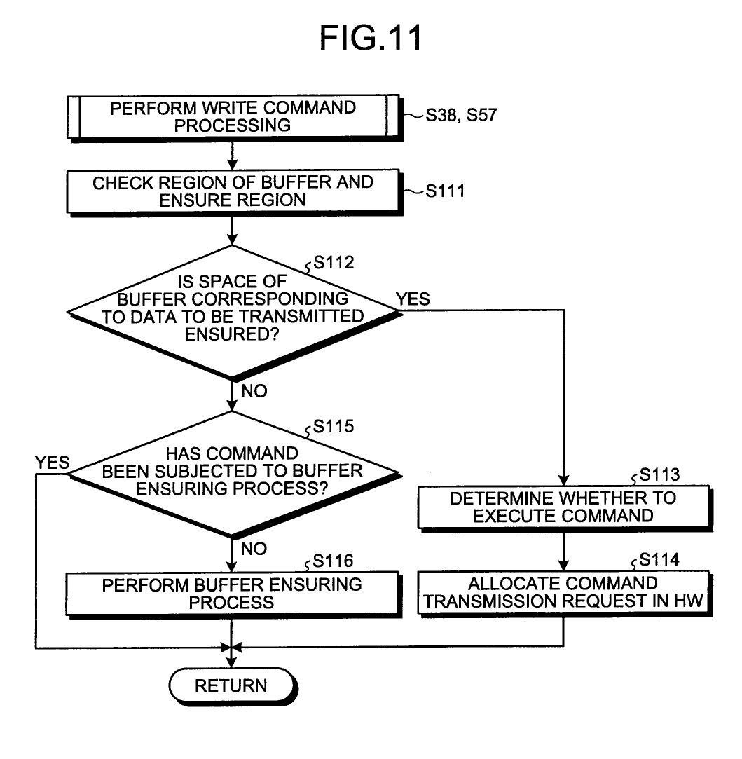

Next, the write command processing in Step S38 of FIG. 7 and Step S57 of FIG. 8 will be described in detail. FIG. 11 is a flowchart illustrating an example of the write command processing. First, the write control unit 471 checks whether there is a sufficient free space to receive the amount of written data designated by a write command in the write cache 431 of the buffer 430 on the basis of the resource information for write and ensures a region corresponding to the amount of data to be transmitted in the write cache 431 (Step S111).

When the region corresponding to the amount of data to be transmitted is ensured in the write cache 431 (Yes in Step S112), the write control unit 471 determines to execute the write command (Step S113). In this case, the resource management unit 474 calculates the free space of the write cache 431 which is changed by the writing of the data transmitted by the write command and updates the resource information for write in the resource information storage unit 465. A write command transmission request is allocated to the hardware (in this case, the host I/F 410) (Step S114) and the process returns to the flowcharts shown in FIG. 7 or FIG. 8.

When the region corresponding to the amount of data to be transmitted is not ensured in the write cache 431 (No in Step S112), it is determined whether the command has been subjected to a process of ensuring the write cache 431 of the buffer 430 (Step S115). When the command has been subjected to the process of ensuring the write cache 431 (Yes in Step S115), the write command processing ends and the process returns to the flowcharts shown in FIG. 7 or FIG. 8.

When the command has not been subjected to the process of ensuring the write cache 431 (No in Step S115), a region with a sufficient size to receive the amount of transmission data designated by the write command is ensured in the write cache 431 of the buffer 430 (Step S116) and the process returns to the flowcharts shown in FIG. 7 or FIG. 8.

As described above, in the write command processing, when it is possible to ensure a free space corresponding to the amount of data to be written in the write cache 431, the write command is executed. When it is difficult to ensure a free space corresponding to the amount of data to be written in the write cache 431, a process of ensuring the free space in the write cache 431 is performed.

The above-mentioned processes are independently performed. Next, the flow of the reordering process according to the first embodiment will be described in detail with reference to the drawings.

### <Outline of Reordering Process>

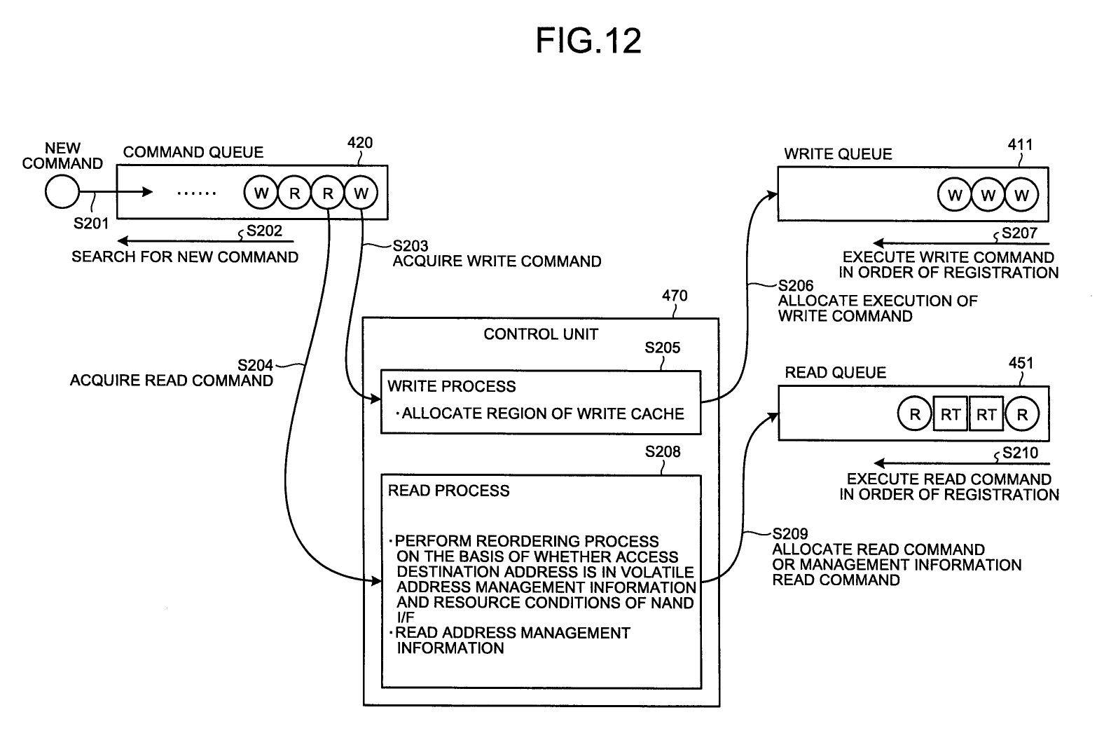

FIG. 12 is a diagram schematically illustrating the reordering process. When a new command is allocated in the command queue 420 (Step S201), the control unit 470 searches for the new command in the command queue 420 (Step S202) and acquires a write command or a read command (Step S203 or S204). In FIG. 12, W indicates the write command.

When the write command is acquired (Step S203), the control unit 470 performs a write process (Step S205). As described above, in the write process, a free space for writing data is ensured in the write cache 431 and data to be written by the acquired write command is allocated to the ensured free space. The execution of the write command is allocated in the write queue 411 (Step S206) and the write command is executed in the order in which it is allocated in the write queue 411 (Step S207).

When the read command is acquired (Step S204), the control unit 470 performs a read process (Step S208). As described above, in the read process, the reordering process is performed which changes the execution order of the read commands, according to whether the physical address of the access destination of the read command in the NAND memory 30 is in the volatile address management information, and also changes the execution order of the read commands that can be immediately executed, on the basis of the resource conditions of the NAND I/F 440 and the reusability of the read command. When the physical address of the access destination of the read command in the NAND memory 30 is not in the volatile address management information, a management information read command to read the address management information of the read command is created. Then, the read command or the management information read command is allocated in the read queue 451 (Step S209) and the read command is executed in the order in which it is allocated in the read queue 451 (Step S210).

### <Reordering Process Based on Whether Data Recording Position is Resolved During Read Process>

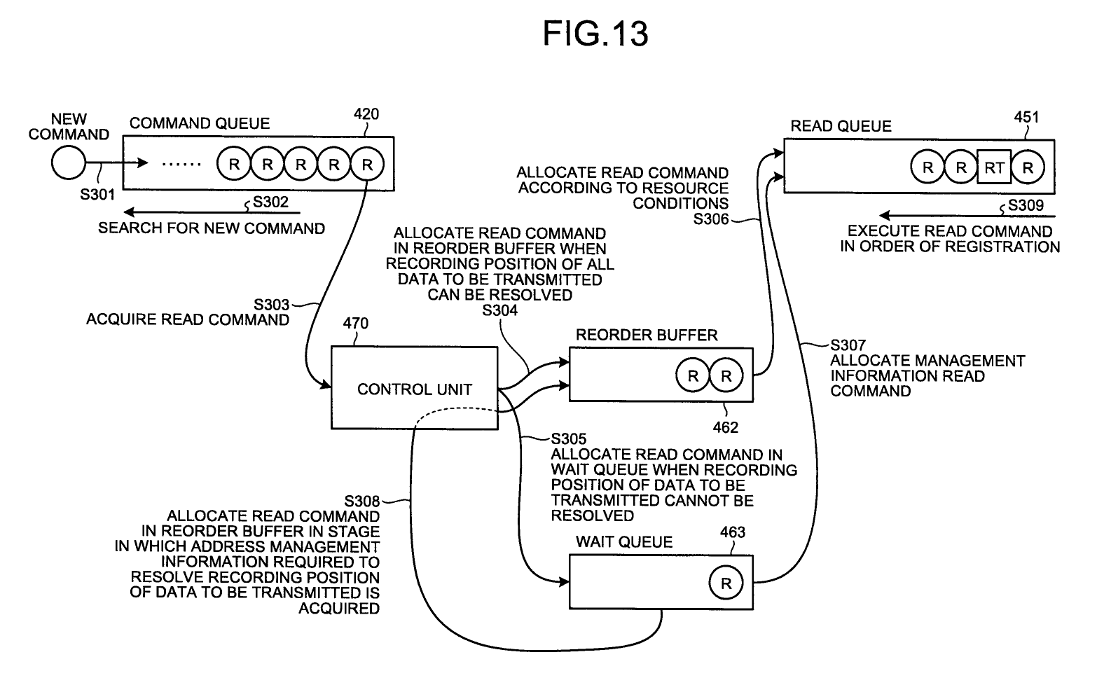

FIG. 13 is a diagram schematically illustrating the outline of the reordering process during the read process. When a new command is allocated in the command queue 420 (Step S301), the control unit 470 searches for the new command in the command queue 420 (Step S302) and acquires a read command (Step S303).

Then, the control unit 470 sorts the LBAs of the read command using the address information cache 461 on the basis of whether the LBA can be converted into the physical address in the NAND memory 30 (Steps S304 and S305). When it is possible to resolve the recording position of all data to be transmitted using the volatile address management information of the address information cache 461, the read command is allocated in the reorder buffer 462 (Step S304). When it is difficult to resolve the recording position of all data to be transmitted using the volatile address management information, the read command is stored in the wait queue 463 (Step S305).

Then, the control unit 470 determines whether to execute the read command allocated in the reorder buffer 462 on the basis of the resource conditions of the NAND I/F 440 and allocates an executable read command in the read queue 451 (Step S306).

The control unit 470 generates a management information read command to acquire address management information capable of resolving the recording position of all data to be transmitted by the read commands allocated in the wait queue 463 and allocates the management information read command in the read queue 451 (Step S307). In the state in which the address management information required to resolve the recording position of the data to be transmitted is included, the read commands in the wait queue 463 are allocated in the reorder buffer 462 through the control unit 470. The read commands allocated in the reorder buffer 462 are allocated in the read queue 451 according to the resource conditions, as described in Step S306.

Then, the read commands are executed in the order in which they are allocated in the read queue 451 (Step S309).

### <Reordering Process According to Use Conditions of Channel>

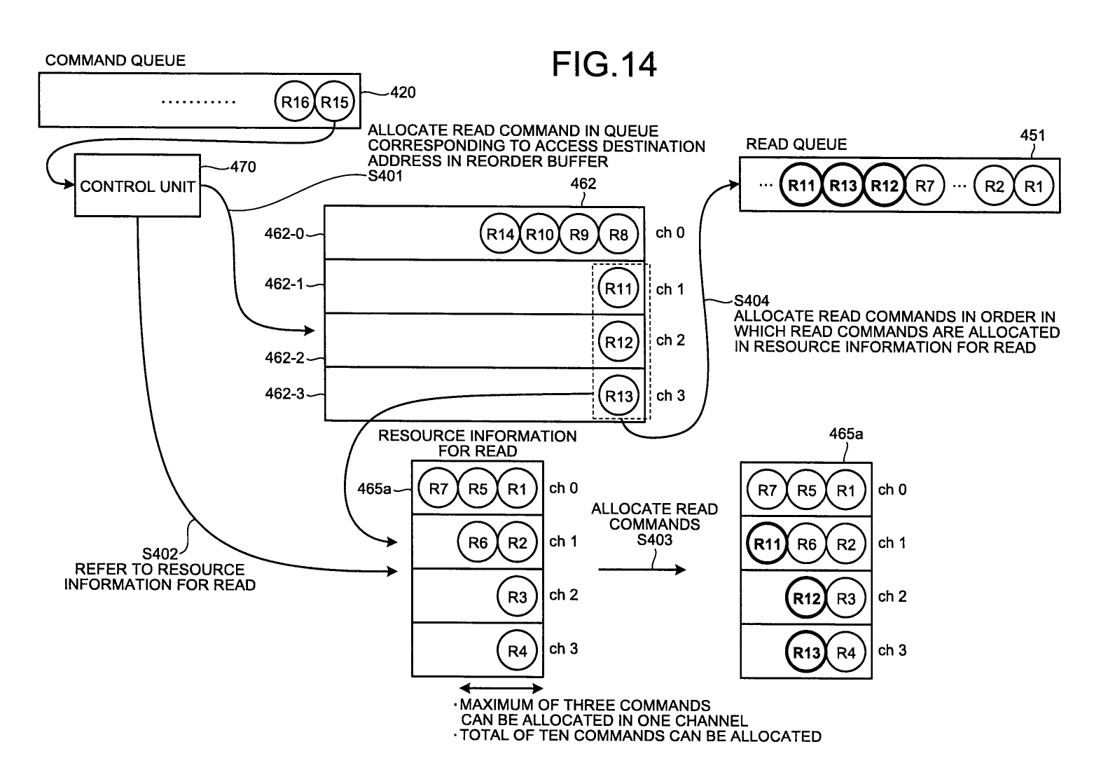

FIG. 14 is a diagram schematically illustrating the outline of the reordering process based on the use conditions of channels. FIG. 14 shows the details of a process of allocating the read command from the reorder buffer 462 to the read queue 451 in FIG. 13. In this embodiment, it is assumed that read commands R1 to R7 have been allocated in the read queue 451.

First, the control unit 470 acquires the read commands from the command queue 420 and allocates, in the reorder buffer 462, the read commands capable of resolving the physical address of an access destination in the NAND memory 30 using the volatile address management information of the address information cache 461 (Step S401). In this case, it is assumed that read commands R8 to R14 are sequentially allocated in the command queue 420, and the read commands R8 to R14 are allocated in the queues of the parallel operation elements 31a to 31d, which are access destinations, among queues 462-0 to 462-3 which are respectively provided for the channels ch0 to ch3 (parallel operation elements 31a to 31d) in the reorder buffer 462. For example, since the access destination of the read commands R8 to R10 and R14 are the parallel operation element 31a, the read commands R8 to R10 and R14 are allocated in the queue 462-0 corresponding to the channel ch0 in the reorder buffer 462. The read commands R11, R12, and R13 are allocated in the queues 462-1, 462-2, and 462-3 corresponding to the channels ch1, ch2, and ch3 in the reorder buffer 462, respectively.

Then, the control unit 470 refers to the registration conditions of the commands in the parallel operation elements 31a to 31d with reference to resource information 465a for read in the resource information storage unit 465 (Step S402). It is assumed that the number of all commands allocated in the NAND memory 30 is limited to 10 and the maximum number of commands allocated in each of the parallel operation elements 31a to 31d is 3. That is, it is assumed that, when ten read commands are allocated in the resource information 465a for read, a new command cannot be allocated in the read queue 451 and, when three read commands are allocated in one of the channels ch0 to ch3, a new command cannot be allocated in the channel.

In the example shown in FIG. 14, the control unit 470 determines that three new commands can be allocated since the number of all command allocates in the NAND memory 30 is 7. Then, the control unit 470 searches for a channel which has the smallest channel number and corresponds to the parallel operation element having the smallest number of commands allocated therein in the resource information 465a for read. Then, the control unit 470 allocates the read commands in the free space from the searched channel of the resource information 465a for read in a round-robin fashion (Step S403), thereby updating the resource information 465a for read.

In this example, the smallest number of commands is allocated in the channel ch2 of the resource information 465a for read and the channel ch2 has a small channel number. Therefore, first, the read command R12 is allocated in the channel ch2. Then, the read command R13 is allocated in the channel ch3 and the read command R11 is allocated in the channel ch1. Since the number of commands that can be allocated in the entire NAND memory 30 is 10 and seven commands have been allocated before the registration process, three read commands are allocated. In addition, since three commands are allocated in the channel ch0, no read command is allocated.

Then, the read commands are allocated from the reorder buffer 462 to the read queue 451 in the order in which they are allocated in the resource information 465a for read (Step S404). Since the read commands R12, R13, and R11 are sequentially allocated in the resource information 465a for read in Step S403, the read commands are allocated in the read queue 451 in this order. As a result, the read command R12, not the read command R8, is allocated after the read command R7 in the read queue 451.

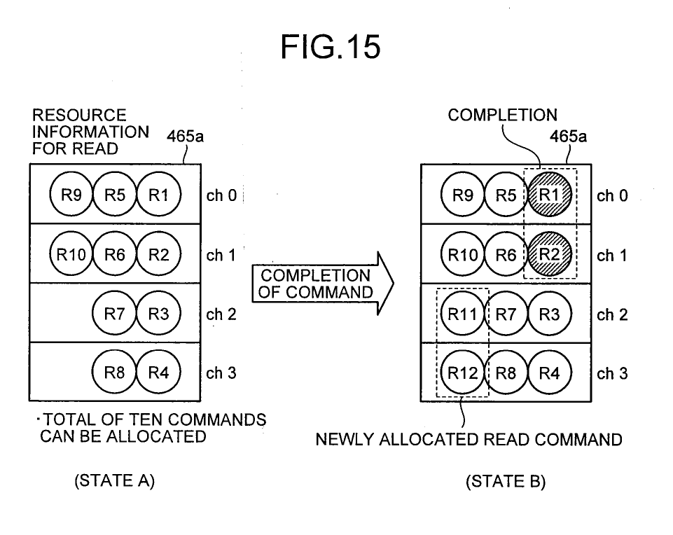

In the example shown in FIG. 14, the number of commands that are input to the NAND memory 30 at the beginning is 7 smaller than 10, which is the number of commands that can be allocated. However, a method of allocating commands when ten commands are allocated at the beginning will be described below. FIG. 15 illustrates diagrams of examples of the registration of the read commands to the resource information for read when the number of allocated commands is limited. As shown in FIG. 15(a), ten read commands R1 to R10 are allocated in the resource information 465a for read. Therefore, in this state, it is difficult to allocate the read command any more.

Then, as shown in FIG. 15(b), when the read commands R1 and R2 are processed, it is possible to input two read commands. Here, two new read commands R11 and R12 are respectively allocated in the channels ch2 and ch3 according to the above-mentioned rule.

As such, when there is a limit in the total number of commands input to the NAND memory 30, a new command is allocated after the process on the command is completed and the number of commands is less than the limit.

### <Read Control of Address Management Information>

In the above description using the flowcharts, the input of the management information read command to the read queue 451 is performed by the same process as that performed on the read command, but the invention is not limited to this method. The input to the management information read command to the read queue 451 may be performed by other methods.

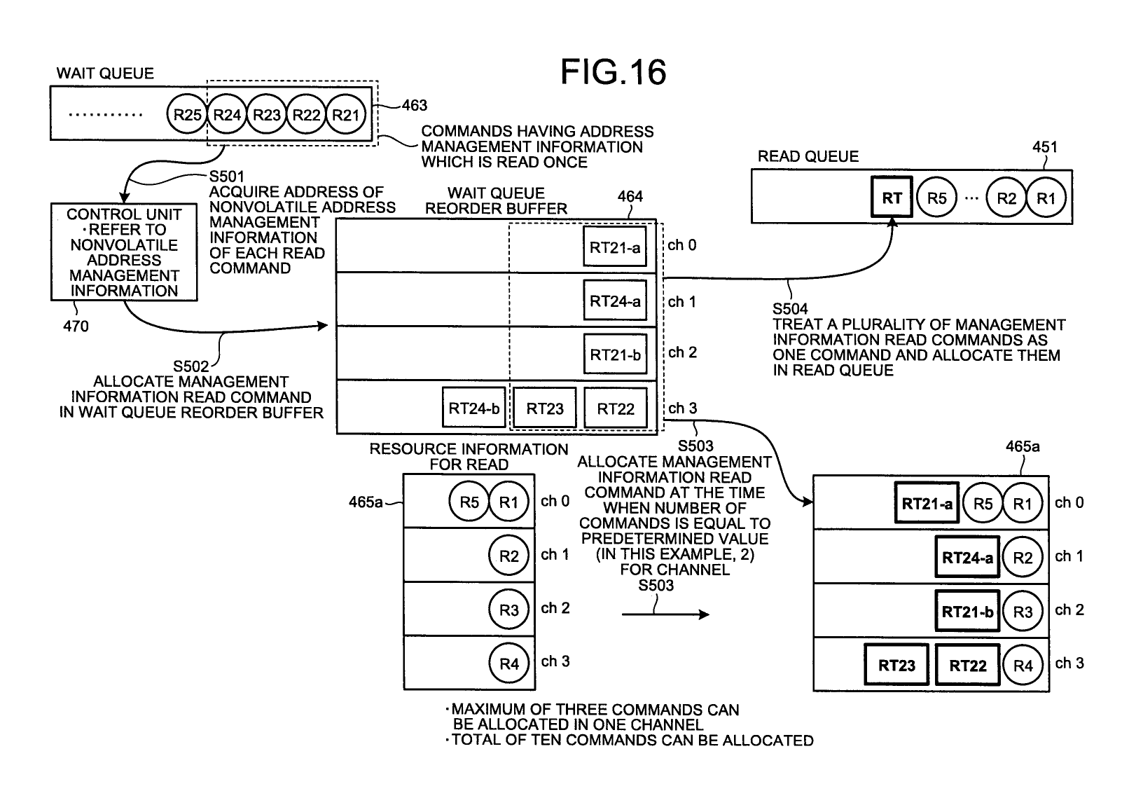

FIG. 16 is a diagram schematically illustrating the outline of the reordering process performed on the basis of the use conditions of the channels. FIG. 16 shows the details of a process of allocating the management information read command from the wait queue 463 to the read queue 451 in FIG. 13. It is assumed that the read commands R1 to R5 have been allocated in the read queue 451.

First, the control unit 470 acquires the address of the nonvolatile address management information required to access the read commands allocated in the wait queue 463 (Step S501). In this case, for example, the address of the nonvolatile address management information for a plurality of read commands may be acquired. In this example, it is assumed that the address of the nonvolatile address management information of four read commands R21 to R24 is acquired.

Then, the control unit 470 creates a management information read command using the address of the nonvolatile address management information of each acquired read command and allocates the management information read command to the wait queue reorder buffer 464 (Step S502). Since the read command R21 accesses two parallel operation elements 31a and 31c, the following two management information read commands are generated as the management information read commands: a management information read command RT21-a for acquiring address management information during access to the parallel operation element 31a; and a management information read command RT21-b for acquiring address management information during access to the parallel operation element 31c. Since each of the read commands R22 and R23 accesses the parallel operation element 31d, management information read commands RT22 and RT23 accessing the parallel operation element 31d are generated as the management information read commands. In addition, since the read command R24 accesses two parallel operation elements 31b and 31d, the following two management information read commands are generated as the management information read commands: a management information read command RT24-a for acquiring address management information during access to the parallel operation element 31b; and a management information read command RT24-b for acquiring address management information during access to the parallel operation element 31d.

Then, at the time when the number of management information read commands accumulated in any one of the queues corresponding to the channels of the wait queue reorder buffer 464 is equal to a predetermined value (in this example, 2), the management information read command is allocated in the resource information 465a for read of the resource information storage unit 465 (Step S503). In this case, the management information read command that is not accumulated by one read process (for example, the management information read command RT24-b of the wait queue reorder buffer 464 in FIG. 16) waits until the command is completely processed, or it is allocated as the next read request.

Then, the management information read command allocated in the resource information 465a for read is allocated in the read queue 451 (Step S504). In this example, four management information read commands RT21-a to RT23 are allocated in the resource information 465a for read. The four management information read commands are treated as one read command and are allocated in a read queue.

### <Execution Order Change Process Considering Reusability>

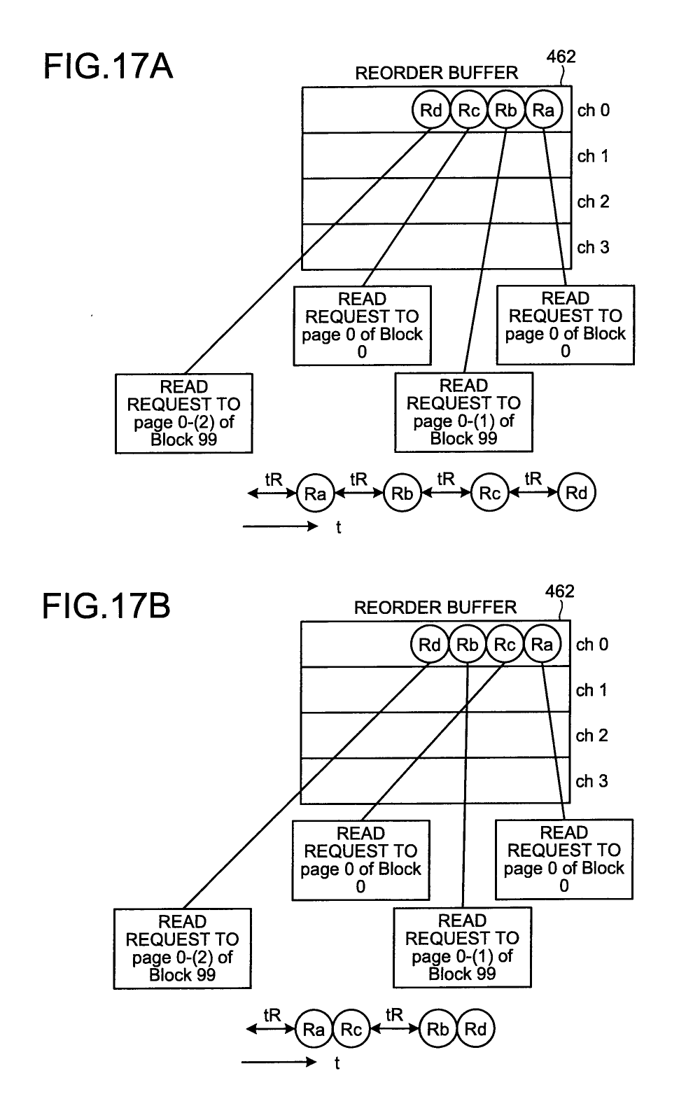

FIGS. 17A and 17B illustrate schematic diagrams of processes of changing the execution order of the read commands considering reusability. Here, it is assumed that four read commands Ra to Rd are allocated in a queue corresponding to the parallel operation element 31a (channel ch0) of the reorder buffer 462. In addition, it is assumed that the read command Ra is a read request to page 0 of block 0, the read command Rb is a read request to a region (1) in the page 0 of block 99, the read command Rc is a read request to the page 0 of the block 0, and the read command Rd is a read request to a region (2) in the page 0 of the block 99.

As shown in FIG. 17A, when the reusability of the commands is not considered, the commands are executed in the order in which they are allocated in the reorder buffer 462, that is, in the order of the read commands Ra, Rb, Rc, and Rd. Therefore, when one read command is executed, data is read from the storage position designated by the read command in the NAND memory 30 and then the next read command is executed. That is, a data read time tR is generated whenever one command is executed.

As shown in FIG. 17B, when the reusability of the commands is considered, the read commands allocated in the reorder buffer 462 are reordered considering reusability. Here, the read command Rc which accesses the same address of that of the read command Ra is arranged after the read command Ra. That is, the read command Rb and the read command Rc are interchanged. As a result, the read command Rb is arranged after the read command Rc. When the reordering process is performed in this way, the read command Ra accessing the same address is executed and then the read command Rc is arranged. Therefore, data is read at a time. The commands Rb and Rd to read different regions (1) and (2) in the same page are executed by one read process. Here, the requests for the same page are arranged. However, the requests for the page subsequent to the page that has been determined to be executed may be arranged by the same method as described above and then executed.

As such, the read commands are reordered such that requests for the page that has been determined to be executed or the next page are arranged and then preferentially allocated in the read queue 451. Therefore, it is possible to effectively use the cache function of the SSD 20 and reduce the unnecessary read time.

In the first embodiment, the commands having dependence therebetween are stopped and it is determined whether the read commands without dependence can access the NAND memory 30 on the basis of the volatile address management information. When the read commands can access the NAND memory 30 using the volatile address management information, the commands stored in the command queue 420 are reordered on the basis of the accumulated state of the commands in the parallel operation elements 31a to 31d. Therefore, it is possible to achieve high-throughput data transmission with a small buffer size while reducing the time required to prepare the transmission of data in the SSD 20.

The address management information of the access destination of the read command that cannot access the NAND memory 30 using the volatile address management information is read from the NAND memory 30 and the management information read command to be allocated in the address information cache 461 is created and executed. In this way, the command having low priority is also executed in the stage in which an access environment is established.

In addition, for the write commands without dependence, the commands stored in the command queue 420 are reordered on the basis of whether the amount of data is sufficient to write data to be transmitted to the write cache 431. In this way, data that can be immediately transmitted to the write cache 431 is processed first, and the commands requiring a free space is processed later. Therefore, it is possible to achieve high-throughput data transmission with a small buffer size while reducing the time required to prepare the transmission of data in the SSD 20.

During the transmission of data by the preceding read command, the subsequent read command allocated in the read queue 451 is issued to the NAND I/F 440 in advance to prepare the transmission of data. Immediately after the transmission of data by the preceding read command completes, the transmission of data by the subsequent allocated read command starts. In this way, it is possible to improve throughput in the transmission of data.

### Second Embodiment

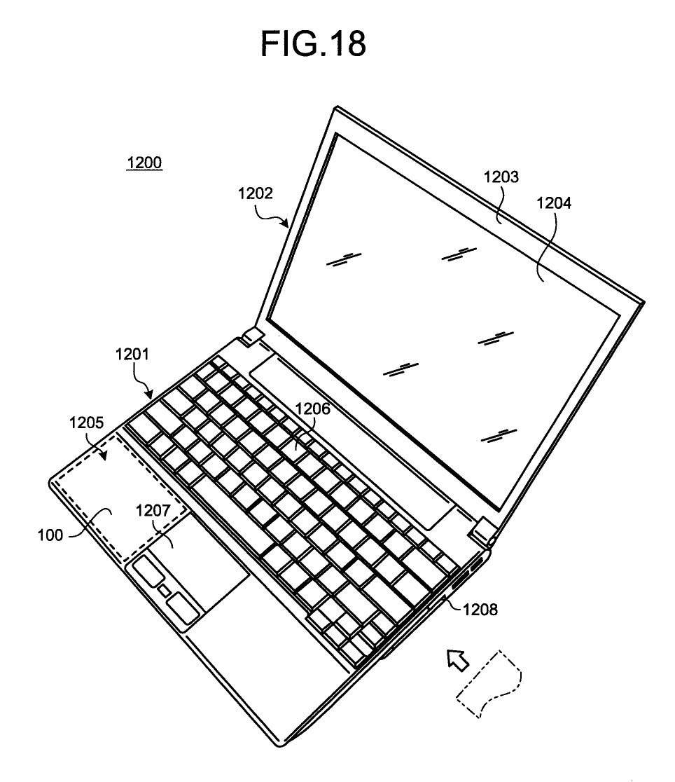

FIG. 18 is a perspective view illustrating an example of a personal computer 1200 provided with an SSD. The personal computer 1200 includes a main unit 1201 and a display unit 1202. The display unit 1202 includes a display housing 1203 and a display device 1204 provided in the display housing 1203.

The main unit 1201 includes a housing 1205, a keyboard 1206, and a touch pad 1207, which is a pointing device. For example, a main circuit board, an Optical Disk Device (ODD) unit, a card slot, and an SSD 100 are provided in the housing 1205.

The card slot is provided adjacent to the circumferential wall of the housing 1205. An opening portion 1208 facing the card slot is provided in the circumferential wall. The user can insert an additional device into the card slot through the opening portion 1208 from the outside of the housing 1205.

The SSD 100 may be provided in the personal computer 1200 instead of an HDD according to the related art and then used. Alternatively, the SSD 100 may be used as an additional device while being inserted into the card slot of the personal computer 1200.

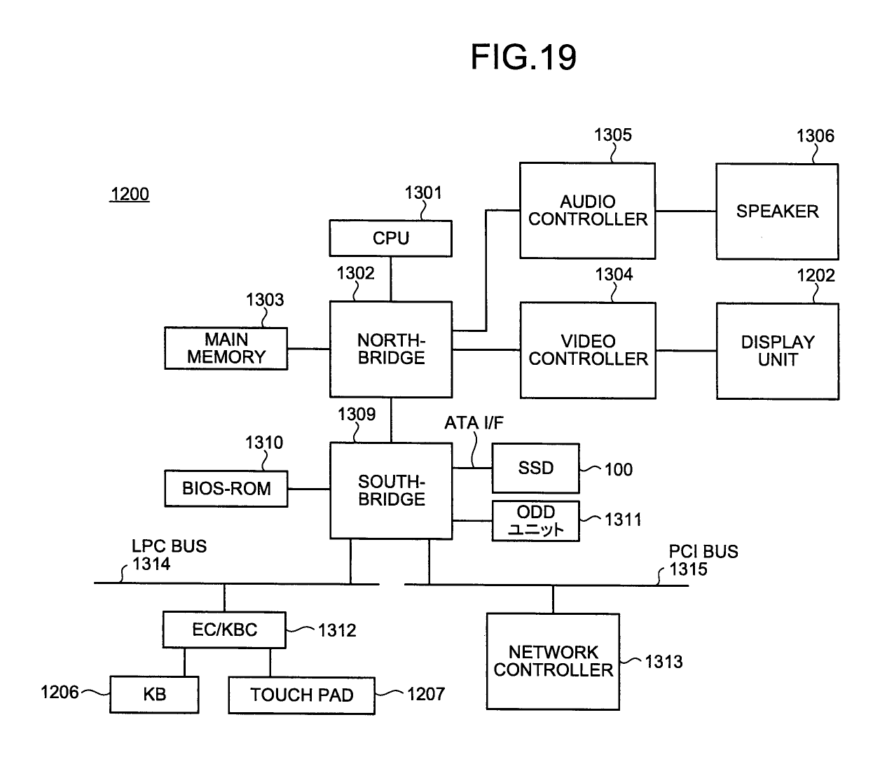

FIG. 19 shows an example of the system structure of the personal computer provided with the SSD. The personal computer 1200 includes, for example, a CPU 1301, a northbridge 1302, a main memory 1303, a video controller 1304, an audio controller 1305, a southbridge 1309, a BIOS-ROM 1310, the SSD 100, an ODD unit 1311, an embedded controller/keyboard controller IC (EC/KBC) 1312, and a network controller 1313.

The CPU 1301 is a processor that is provided in order to control the operation of the personal computer 1200 and executes an operating system (OS) which is loaded from the SSD 100 to the main memory 1303. When the ODD unit 1311 can perform at least one of a process of reading data from an inserted optical disk and a process of writing data to the optical disk, the CPU 1301 performs the process.

In addition, the CPU 1301 executes a system Basic Input Output System (BIOS) stored in the BIOS-ROM 1310. The system BIOS is a program for controlling hardware in the personal computer 1200.

The northbridge 1302 is a bridge device that connects a local bus of the CPU 1301 and the southbridge 1309. The northbridge 1302 includes a memory controller that controls access to the main memory 1303.

The northbridge 1302 has a function of communicating with the video controller 1304 and the audio controller 1305 through an Accelerated Graphics Port (AGP) bus 1314.

The main memory 1303 temporarily stores programs or data and functions as a work area of the CPU 1301. The main memory 1303 is, for example, a RAM.

The video controller 1304 is a video reproduction controller that controls the display unit 1202 used as a display monitor of the personal computer 1200.

The audio controller 1305 is an audio reproduction controller that controls a speaker 1306 of the personal computer 1200.

The southbridge 1309 controls each device on an Low Pin Count (LPC) bus and each device on a Peripheral Component Interconnect (PCI) bus 1315. In addition, the southbridge 1309 controls the SSD 100, which is a storage device storing various kinds of software and data, through an ATA interface.

The personal computer 1200 accesses the SSD 100 in a sector unit. For example, a write command, a read command, and a cache flash command are input to the SSD 100 through the ATA interface.

The southbridge 1309 has a function of controlling access to the BIOS-ROM 1310 and the ODD unit 1311.

The EC/KBC 1312 is a one-chip microcomputer obtained by integrating an embedded controller for managing power with a keyboard controller for controlling the keyboard (KB) 1206 and the touch pad 1207.

The EC/KBC 1312 has a function of turning on or off a power supply of the personal computer 1200 according to the operation of a power button by the user. The network controller 1313 is a communication device that communicates with an external network, such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A memory system comprising:
a nonvolatile memory configured to store data supplied from a host apparatus and to store nonvolatile address management information in which a physical address of the nonvolatile memory and a logical address designated by the host apparatus are associated with each other;
a command queue configured to store a plurality of read and write commands issued by the host apparatus;
an address information cache configured to store volatile address management information which is a portion of the nonvolatile address management information; and
a controller configured to:
read out the nonvolatile address management information required to execute one of the read commands into the address information cache;
retrieve data from the nonvolatile memory according to the volatile address management information stored in the address information cache; and
among the read commands stored in the command queue, preferentially execute the read command whose logical addresses are all found in the volatile address management information.

2. The memory system according to claim 1,
wherein the controller is configured to determine dependence between the plurality of read and write commands stored in the command queue and reorder the read commands being independent from the other write commands.

3. The memory system according to claim 1,
wherein the nonvolatile memory includes a plurality of parallel operation elements which are independently read and written,
at least one of the parallel operation elements is configured to store the nonvolatile address management information,
the controller is configured to perform at least one of the read and write operation on the plurality of parallel operation elements at the same time, and
the controller is configured to preferentially execute, among the read commands whose logical addresses are all found in the volatile address management information, the read command whose logical addresses are associated with the parallel operation element having the least number of commands to be executed.

4. The memory system according to claim 1, further comprising:
a read queue configured to store the read commands to be executed;
a transmission order control unit configured to execute the read commands in the order in which the read commands are allocated in the read queue;
a reorder buffer configured to store the read commands whose logical addresses are all found in the volatile address management information; and
a wait queue configured to store the read commands whose at least one portion of logical addresses is not found in the volatile address management information,
wherein the controller allocates the read commands from the command queue to either the reorder buffer or the wait queue according to the logical addresses of the read commands.

5. The memory system according to claim 4,
wherein the nonvolatile memory includes a plurality of parallel operation elements which are independently read and written,
at least one of the parallel operation elements is configured to store the nonvolatile address management information,
the reorder buffer includes a plurality of queues corresponding to each one of the parallel operation elements,
the controller is configured to allocate the read commands whose logical addresses are all found in the volatile address management information to one of the plurality of queues according to the logical addresses of the read commands.

6. The memory system according to claim 5,
wherein the controller is configured to preferentially allocate to the read queue, among the read commands stored in the reorder buffer, the read commands whose logical addresses are associated with the parallel operation element having the least number of commands to be executed.

7. The memory system according to claim 4,
wherein the controller is configured to determine dependence between the plurality of read and write commands stored in the command queue and allocate the read commands being independent from the other write commands to at least one of the reorder buffer and the wait queue.

8. The memory system according to claim 4, further comprising:
a volatile memory; and
a nonvolatile memory interface that transmits data between the nonvolatile memory and the volatile memory,
wherein the transmission order control unit is configured to, while data of a preceding read command is transmitted, issue a request for a read command following the preceding read command stored in the read queue to the nonvolatile memory interface, and
the nonvolatile memory interface is configured to, after the transmission of the data of the preceding read command has completed, starts data transmission according to the issued request for the succeeding read command.

9. The memory system according to claim 4, further comprising: a wait queue reorder buffer configured to store a management information read command for the read commands stored in the wait queue,
wherein the controller is configured to:
determine the portion of the nonvolatile address management information required to execute the read commands stored in the wait queue;
generate a management information read command to read out the portion of the nonvolatile address management information into the address information cache;
allocate the management information read command to the wait queue reorder buffer; and
allocate the read command stored in the wait queue to the reorder buffer, after the portion of the nonvolatile address management information has been read out to the address information cache.

10. The memory system according to claim 9, wherein the controller is configured to, when there is another read command that has the same address as the read command to be allocated to the read queue or has a successive address, allocate both of the read command and another read command to the read queue.

11. The memory system according to claim 1, further comprising a volatile memory,
wherein the controller is configured to preferentially execute, among the write commands stored in the command queue, the write command whose data size is smaller than a free space of the volatile memory.

12. The memory system according to claim 11, wherein the controller is configured to preferentially execute the write commands without dependence among the write commands stored in the command queue.

13. The memory system according to claim 12, wherein the controller is configured to, when there is no free space in the volatile memory for storing data of the write command without dependence, generates a write command to flush data stored in the volatile memory to the nonvolatile memory.

14. A method of controlling a memory system including a nonvolatile memory, comprising:
storing data supplied from a host apparatus and nonvolatile address management information in which a physical address of the nonvolatile memory and a logical address designated by the host apparatus are associated with each other in the nonvolatile memory;
storing a plurality of read and write commands issued by the host apparatus in a command queue;
storing volatile address management information which is a portion of the nonvolatile address management information in an address information cache;
reading out the nonvolatile address management information required to execute one of the read commands into the address information cache;
retrieving data from the nonvolatile memory according to the volatile address management information stored in the address information cache; and
among the read commands stored in the command queue, preferentially executing the read command whose logical addresses are all found in the volatile address management information.

15. The method according to claim 14, further comprising:
determining dependence between the plurality of read and write commands stored in the command queue; and
reordering the read commands being independent from the other write commands.

16. The method according to claim 14, further comprising:
storing the nonvolatile address management information in at least one of a plurality of parallel operation elements which are independently read and written and which are included in the nonvolatile memory;
performing at least one of the read and write operation on the plurality of parallel operation elements at the same time; and
preferentially executing, among the read commands whose logical addresses are all found in the volatile address management information, the read command whose logical addresses are associated with the parallel operation element having least number of commands to be executed.

17. The method according to claim 14, further comprising:
transmitting data between the nonvolatile memory and a volatile memory through a nonvolatile memory interface;
issuing, while data of a preceding read command is transmitted, a request for a read command following the preceding read command stored in the read queue to the nonvolatile memory interface; and
starting, after the transmission of the data of the preceding read command has completed, data transmission according to the issued request for the succeeding read command in the nonvolatile memory interface.

18. The method according to claim 14, further comprising: preferentially executing, among the write commands stored in the command queue, the write command whose data size is smaller than a free space of the volatile memory.

19. The method according to claim 18, further comprising: preferentially executing the write commands without dependence among the write commands stored in the command queue.

20. The method according to claim 18, further comprising: generating, when there is no free space in the volatile memory for storing data of the write command without dependence, a write command to flush data stored in the volatile memory to the nonvolatile memory.
